(19) United States
(12) Patent Application Publication
(10) Pub. No.: US 2005/0262180 A1
(43) Pub. Date: Nov. 24, 2005

(54) Using a common key to manage separate, independent I/O and worker theread queues

(76) Inventors: Lowell D. Palecek, White Bear Township, MN (US); Keith G. Hauer-Lowe, Roseville, MN (US)

Correspondence Address: UNISYS CORPORATION;MS 4773, PO BOX 64942, ST. PAUL, MN, 55164-0942, US

(21) Appl. No.: 10/848,906

(22) Filed: May 19, 2004

(51) Int. Cl. G06F 15/16

(52) U.S. Cl. 709/200

(57) ABSTRACT

An apparatus for and method of improving the efficiency of service request/response activity between multiple clients and multiple service applications within a complex environment. The key to the technique is the use of separate, independent thread pools to maintain I/O and computational activity. A common client key is utilized with both thread pools for a given client service request to ensure the needed coordination.

### CROSS REFERENCE TO CO-PENDING APPLICATIONS

U.S. patent application Ser. No. ______, filed ______, and entitled, “Cool ICE data Wizard”; U.S. patent application Ser. No. ______, filed ______, and entitled, “Cool ICE Column Profiling”; U.S. patent application Ser. No. ______, filed ______, and entitled, “Cool ICE OLEDB Consumer Interface”; and U.S. patent application Ser. No. ______, filed ______, and entitled, “Cool ICE State Management” are commonly assigned co-pending applications.

### BACKGROUND OF THE INVENTION

1. Field of the Invention

The present invention generally relates to data base management systems and more particularly relates to enhancements for improving the efficiency of access to data base management systems.

2. Description of the Prior Art

Data base management systems are well known in the data processing art. Such commercial systems have been in general use for more than 20 years. One of the most successful data base management systems is available from Unisys Corporation and is called the Classic MAPPER® data base management system. The Classic MAPPER system can be reviewed using the Classic MAPPER User's Guide which may be obtained from Unisys Corporation.

The Classic MAPPER system, which runs on proprietary hardware also available from Unisys Corporation and on an industry compatible personal computer under a Windows Server operating system, provides a way for clients to partition data bases into structures called filing cabinets and drawers, as a way to offer a more tangible format. The BIS (Business Information System) data base manager utilizes various predefined high-level instructions whereby the data base user may manipulate the data base to generate human-readable data presentations called “reports”. The user is permitted to prepare lists of the various predefined high-level instructions into data base manager programs called “BIS Runs”:. Thus, users of the Classic MAPPER system may create, modify, and add to a given data base and also generate periodic and aperiodic reports using various BIS Runs.

Within complex network environments, some client/server applications (e.g., the data access usage load for an electronic information integration service) are not clearly dominated by either the network communications or the computational work. Some operations may be computation intensive, while at the same time the server needs to be able to handle a large volume of small client requests. It is common in the prior art for a server application to utilize a common thread pool for both computational activities and for Input/Output activities. This common thread pool can be optimized or tuned for either a high volume of small requests or a much smaller number of prolonged operations, but not for a mix of the two. Microsoft has created I/O completion ports to coordinate a pool of worker threads to process completed asynchronous I/O to or from “files”, which can be actual files or network communications mechanisms such as sockets or named pipes. Such a pool can produce optimal throughput if the workload is either I/O bound or computation bound, but has bottlenecks if a few long computations are mixed among many short exchanges. In this case, the long computations may tie up all the threads, so that the server becomes unresponsive to the remaining clients. Conversely, the many clients may tie up all the threads so that the execution engine cannot stay busy.

### SUMMARY OF THE INVENTION

The present invention overcomes the disadvantages of the prior art by providing a method of and apparatus for improving the efficiency of honoring client requests by server applications, particularly within the Internet environment. The present invention utilizes two separate and independent thread pools. A first thread pool corresponds to I/O handling, and a second thread pool is associated with command processing threads.

Input from clients is read into a first-in-first-out (FIFO) Microsoft Windows-type queue called an “I/O completion port”. An I/O handler thread takes the top message buffer off of the input queue and places it into the execution queue. Then it immediately goes back to the queue to get the next input.

Input is accepted from clients as fast as it arrives. The underlying I/O system is kept busy as long as there are clients sending input. There is no need to wait for a command from one client to be completed before accepting another command from the same or different client.

A command processing thread takes a message off of the execution queue and processes it. When the operation is done, the thread tells the asynchronous I/O system to send the result back to the client. The execution thread gets the next available message off the queue without waiting for the “send” to complete.

The command processing threads are kept busy as long as there is work to do. They do not spend time waiting to receive or send messages. The I/O handler threads keep the execution queue stocked as fast as the I/O system can receive messages. Before processing a message, an execution thread issues a new “read” from the client, so that the client can abort a long operation if necessary. While this thread is busy processing the input message, another thread from the queue can retrieve an abort message from the queue and cancel the first thread's operation.

We have two independent groups of workers (the two thread pools). The workers in each group are doing their jobs as fast as they can without keeping track of what the other group is doing, or even what the other workers in their own group are doing.

The central question is how to coordinate the work. The solution is to use a second I/O completion port for the execution queue, even though the queue is not directly associated with the I/O system. The essential aspect of the I/O completion port is that each item in the queue consists of an identifying numerical key, and a data buffer. We coordinate the two queues by using the same key value in both queues, to identify a particular client.

The preferred mode of the present invention includes a third thread pool that accepts connections from clients. Each time it accepts a connection, it assigns a unique numerical identifier for the client. It then tells the Windows runtime system to associate the client connection with the first of our I/O completion ports, using the client identifier as the key. The I/O system then uses the key to add notifications of completed I/O operations to the queue. When an I/O handler thread takes a message off of the input queue, it uses the I/O completion port key to place the message on the execution queue. When a command processing thread takes the message off of the execution queue, it uses the key to identify the client, which enables it to act on behalf of the client, and to send the result back to the client.

### BRIEF DESCRIPTION OF THE DRAWINGS

Other objects of the present invention and many of the attendant advantages of the present invention will be readily appreciated as the same becomes better understood by reference to the following detailed description when considered in connection with the accompanying drawings, in which like reference numerals designate like parts throughout the figures thereof and wherein:

FIG. 1 is a pictographic view of the hardware of the preferred embodiment;

FIG. 2 is a pictorial diagram of the @SPI command process flow;

FIG. 3, consisting of FIG. 3A and FIG. 3B, is a main class diagram showing the uses of the separate thread pools;

FIG. 4 is a detailed flow diagram showing dual completion port queues; and

FIG. 5 is a table showing the description of the message utilized in FIG. 4.

### DETAILED DESCRIPTION OF THE PREFERRED EMBODIMENTS

The present invention is described in accordance with several preferred embodiments which are to be viewed as illustrative without being limiting. These several preferred embodiments are based upon Series 2200 hardware and operating systems, the Classic MAPPER data base management system, and the BIS/Cool ICE software components, all available from Unisys Corporation. Also commercially available are industry standard personal computers operating in a Microsoft Windows environment.

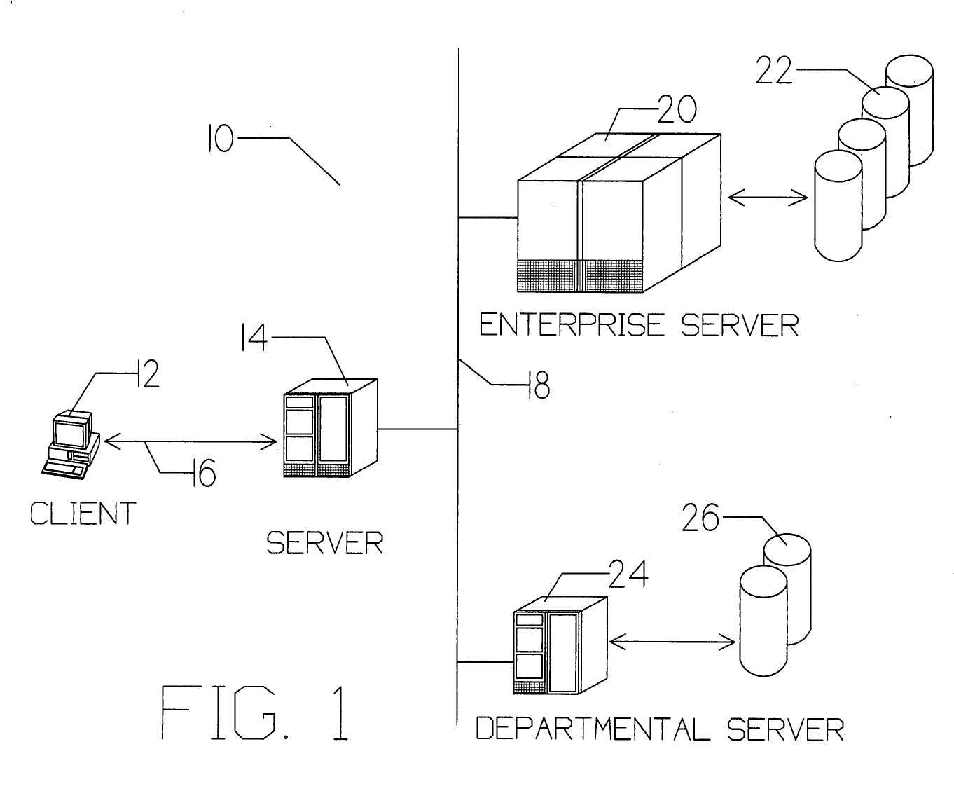

FIG. 1 is a pictorial diagram of hardware suite 10 of the preferred embodiment of the present invention. The client interfaces with the system via terminal 12. Preferably, terminal 12 is an industry compatible, personalized computer having a current version of the Windows operating system and suitable web browser, all being readily available commercial products. Terminal 12 communicates over world wide web access 16 using standardized HTML protocol, via Server 14.

The BIS/Cool ICE system is resident in Enterprise Server 20 and accompanying storage subsystem 22, which is coupled to Web Server 14 via WAN (Wide Area Network) 18. In the preferred mode, Server 14 is owned and operated by the enterprise owning and controlling the proprietary legacy data base management system. Server 14 functions as the Internet access provider for terminal 12 wherein world wide web access 16 is typically a dial-up telephone line. This would ordinarily be the case if the shown client were an employee of the enterprise. On the other hand, web server 14 may be a remote server site on the Internet if the shown client has a different Internet access provider. This would ordinarily occur if the shown client were a customer or guest.

In addition to being coupled to WAN 18, Enterprise Server 20, containing the BIS/Cool ICE system, is coupled to departmental server 24 having departmental server storage facility 26. Additional departmental servers (not shown) may be similarly coupled. The enterprise data and enterprise data base management service functionality typically resides within enterprise server 20, departmental server 24, and any other departmental servers (not shown). Normal operation in accordance with the prior art would provide access to this data and data base management functionality.

In the preferred mode of the present invention, access to this data and data base management functionality is also provided to users (e.g., Internet terminal 12) coupled to Intranet 18. As explained below in more detail, web server 14 provides this access utilizing the BIS/Cool ICE system.

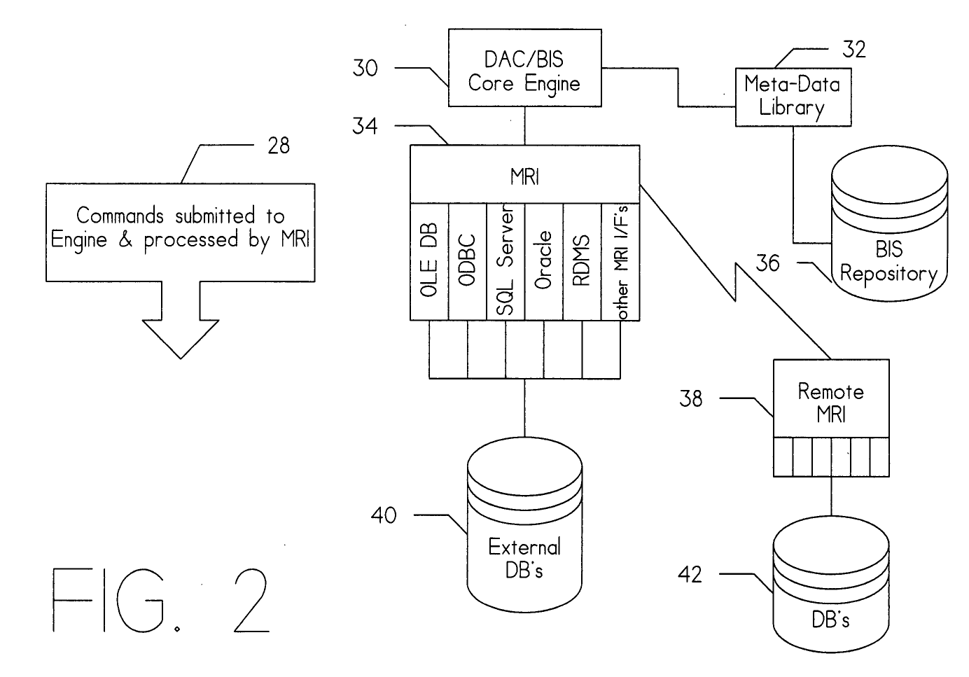

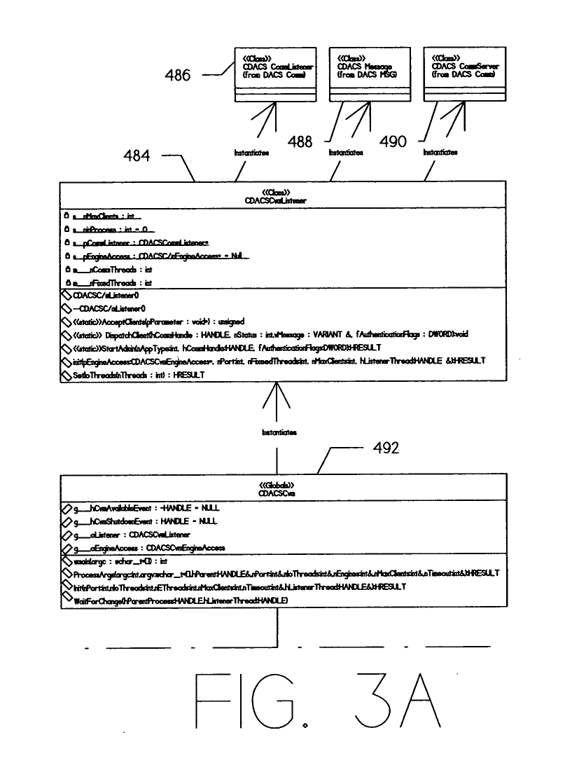

FIG. 2 is a functional diagram showing the major components of the @SPI (stored procedure interface) command process flow. This command is a part of the MRI (BIS Relational Interface) set of commands and combines many of the attributes of the previously existing @FCH (relational aggregate fetch) and @SQL (standard query language) commands. However, it is specifically targeted to executing stored procedures.

Command set 28 represents the commands defined for processing by MRI. In addition to @SPI, @FCH, and @SQL, @LGN (log on), MRI recognizes @LGF (log off), @DDI (data definition information), @RAM (relational aggregate modify), @TRC (trace relational syntax), @MQL (submit SQL syntax to a BIS data base) as the remaining commands. DAC/BIS core Engine 30 provides the basic logic for decode and execution of these commands. MRI 34 has relational access to data via the data base management formats shown to external data bases 40. In addition, MRI 34 can call upon remote MRI 38 to make similar relational access of remote data bases 42.

BIS core engine 30 executes commands utilizing meta-data library 32 and BIS repository 36. Meta-data library 32 contains information about the data within the data base(s). BIS repository 36 is utilized to store command language script and state information for use during command execution.

The @SPI command has the following basic format: @SPI, c, d, lab, db, edsp?, action, wrap, vert ‘sp-syntax’, vpar1 . . . , vparN, typ1 . . . . typN. Fields c and d refer to the cabinet and drawer, respectively, which hold the result. The lab field contains a label to go to if the status in the vstat variable specifies other than normal completion. The required db field provides the data base name. The edsp? field specifies what is to be done with the result if an error occurs during execution.

The sub-field labeled action defines what action is to be performed. The options include execution, return of procedures lists, etc. The wrap sub-field indicates whether to truncate or wrap the results. The vert sub-field defines the format of the results. The name of the stored procedure is placed into the sp-syntax field. The vpar provides for up to 78 variables that correspond to stored procedure parameters. Finally, the typ field defines the type of each stored procedure parameter.

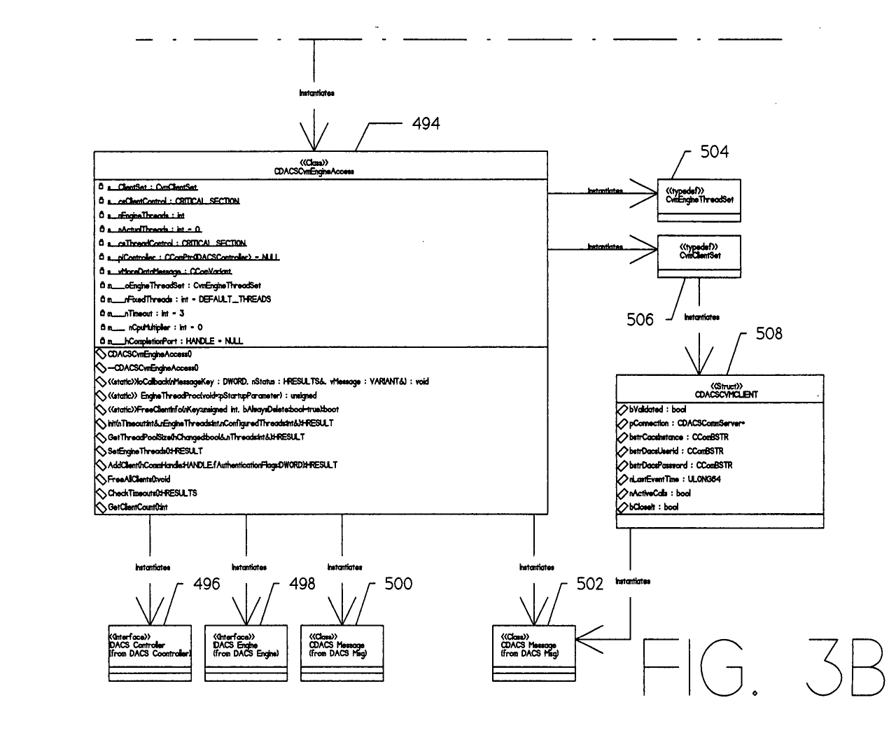

FIG. 3 containing FIG. 3A and FIG. 3B provides a detailed class diagram for the multiple thread pool architecture. Global communication activates service at element 492. This instantiates the I/O thread pool at element 484. This in turn instantiates the communication listener at element 486, the message activity at element 488, and the communication server activity at element 490.

Element 492 also instantiates element 494 to activate the computation thread pool. The engine is instantiated at element 504, the client key is instantiated at element 506 which in turn instantiates element 508 for client service. Similarly, the computation controller (i.e., element 496), the computation engine (i.e., element 498), and the message activity (i.e., element 500) are instantiated by element 494. The message activity of element 502 may be instantiated by element 494 or element 508.

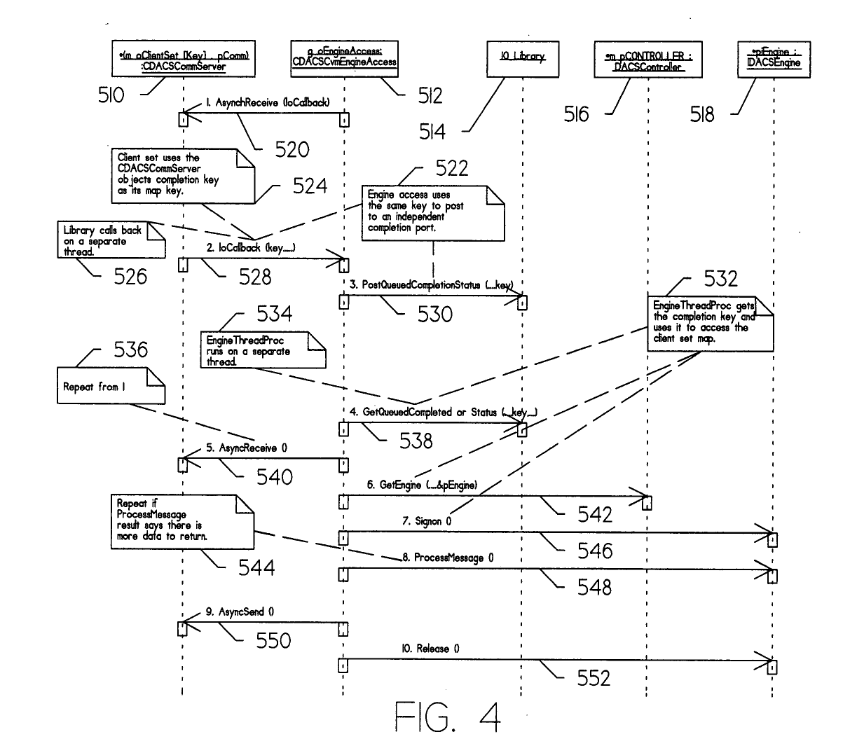

FIG. 4 is a detailed schematic view of the operation of the present invention. Shown are the interaction of the communication server at element 510, the engine access at element 512, the I/O library at element 514, the controller at element 516, and the engine at element 518.

Message 520 requests receipt of a message from the client. The callback message 528 can result from the action of any of the elements 522, 524, or 526. The incoming message is posted at element 530. At element 538, the oldest message is retrieved from the queue resulting from either element 534 or element 532. A message is generated at element 540 permitting the client to cancel the activity. Element 536 shows that this is a repeat of the first message.

Element 542 is a message for getting the engine interface. Again, this can be initiated by element 532. The client credentials are transferred to the engine via the message of element 546. Element 548 marshals the client's message information for use by the engine. Element 544 shows that this can be repeated for additional data. The response is provided to the client via element 550. Element 552 releases the engine interface, because the requested service has been accomplished.

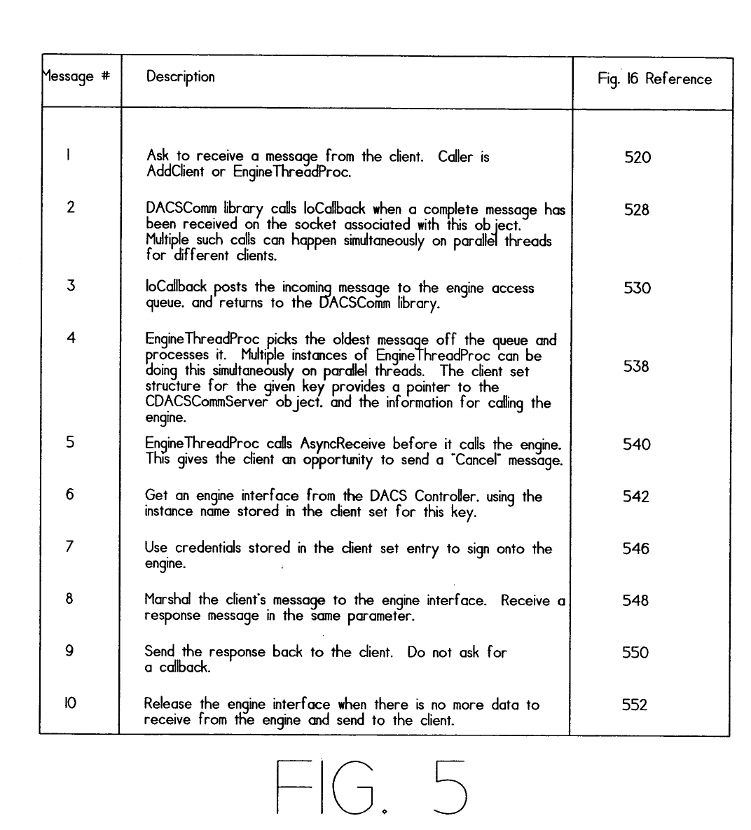

FIG. 5 is a listing and description of all of the messages shown within FIG. 4.

Having thus described the preferred embodiments of the present invention, those of skill in the art will be readily able to adapt the teachings found herein to yet other embodiments within the scope of the claims hereto attached.

1. An apparatus comprising:
a. a plurality of client applications which generate service requests;
b. a service application responsively coupled to said plurality of client applications;
c. a first service request requiring Input/Output activity and computational activity generated by a first one of said plurality of client applications transferred to said service application;
d. a first thread pool responsively coupled to said service application which handles said Input/Output activity of said first service request; and
e. a second thread pool responsively coupled to said service application which handles said computational activity of said first service request.

2. The apparatus of claim 1 further comprising a first client key which uniquely identifies said first one of said plurality of client applications to said first thread pool and said second thread pool.

3. The apparatus of claim 2 wherein a second one of said plurality of client applications generates a second service request transferred to said service application requiring Input/Output activity and computational activity.

4. The apparatus of claim 3 further comprising a second client key which uniquely identifies said second one of said plurality of client applications to said first thread pool and said second thread pool.

5. The apparatus of claim 4 further comprising a user terminal responsively coupled to a data base management system via a publically accessible digital data communication network and wherein said first client application is located within said user terminal and said service application is located within said data base management system.

6. A method of managing a service request requiring Input/Output activity and computational activity of a client application by a service application comprising:
a. transferring said service request from said client application to said service application;
b. handling said Input/Output activity using a first thread pool; and
c. handling said computational activity using a second thread pool.

7. A method according to claim 6 further comprising a client identifier which identifies said client application to said first thread pool and said second thread pool.

8. A method according to claim 7 wherein said transferring step further comprises transferring said service request to said service application via a publically accessible digital data communication network.

9. A method according to claim 8 further comprising a user terminal wherein said client application is located within said user terminal.

10. A method according to claim 9 further comprising a data base management system wherein said service application is located within said data base management system.

11. An apparatus comprising:
a. means for generating a service request requiring Input/Output activity and computational activity;
b. means responsively coupled to said generating means for honoring said service request via said Input/Output activity and said computational activity;
c. first thread pool means responsively coupled to said honoring means for handling said Input/Output activity; and
d. second thread pool means responsively coupled to said honoring means for handling said computational activity.

12. An apparatus according to claim 11 further comprising means for uniquely identifying said generating means to said first thread pool means and said second thread pool means.

13. An apparatus according to claim 12 wherein said identifying means further comprises a client key.

14. An apparatus according to claim 13 wherein said honoring means further comprises a data base management system.

15. An apparatus according to claim 14 wherein said generating means further comprises a user terminal.

16. In a data processing system having a client application which generates a service request requiring Input/Output activity and computational activity responsively coupled to a service application, the improvement comprising:
a. a first thread pool responsively coupled to said service application for handling said Input/Output activity; and
b. a second thread pool responsively coupled to said service application for handling said computational activity.

17. The improvement according to claim 16 further comprising a client key which identifies said client application to said first thread pool and said second thread pool.

18. The improvement according to claim 17 further comprising a user terminal containing said client application.

19. The improvement according to claim 18 further comprising a publically accessible digital data communication network responsively coupled between said user terminal and said service application.

20. The improvement according to claim 19 further comprising a data base management system containing said service application.

21. An apparatus comprising:
a. a plurality of client applications which generate a plurality of service requests;
b. a service application responsively coupled to said plurality of client applications;
c. a first of said plurality of service requests requiring Input/Output activity and computational activity generated by a first one of said plurality of client applications transferred to said service application;
d. a first thread pool responsively coupled to said service application which handles said Input/Output activity of said first service request;
e. a second thread pool responsively coupled to said service application which handles said computational activity of said first service request.
f. a first client key which uniquely identifies said first one of said plurality of client applications to said first thread pool and said second thread pool;
g. wherein a second one of said plurality of client applications generates a second service request transferred to said service application requiring Input/Output activity and computational activity;
h. a second client key which uniquely identifies said second one of said plurality of client applications to said first thread pool and said second thread pool; and
i. a user terminal responsively coupled to a data base management system via a publically accessible digital data communication network and wherein said first client application is located within said user terminal and said service application is located within said data base management system.
